(19) United States
(12) Patent Application Publication
(10) Pub. No.: US 2026/0156091 A1
(43) Pub. Date: Jun. 4, 2026

(54) USING GENERATIVE ARTIFICIAL INTELLIGENCE TO CREATE MEDIA SYNOPSIS FOR CLIENTS WITH NETWORK LIMITATIONS

(71) Applicant: Meta Platforms, Inc., Menlo Park, CA (US)

(72) Inventors: Yuval Pinchas Borsutsky, Tel Aviv-Yafo (IL); Itay Dar, Herzlyia (IL)

(21) Appl. No.: 19/388,646

(22) Filed: Nov. 13, 2025

Related U.S. Application Data
(60) Provisional application No. 63/721,801, filed on Nov. 18, 2024.

(51) Int. Cl. H04L 51/063; H04L 41/16; H04L 51/10; H04W 28/02

(52) U.S. Cl. CPC H04L 51/063; H04L 41/16; H04L 51/10; H04W 28/0236

(57) ABSTRACT

A system and method to determine text-based descriptions of media content to be delivered to devices are provided. The system may receive a request from a communication device for a content item. The system may further determine a network condition associated with the communication device. The system may analyze the content item and may generate a text description of the content item in response to determining that the network condition is below a predetermined threshold denoting that a quality of telecommunications associated with the communication device includes an unsatisfactory quality level. The system may send the text description of the content item to the communication device to enable a display device of the communication device to present the text description of the content item.

### CROSS-REFERENCE TO RELATED APPLICATIONS

This application claims priority to U.S. Provisional Application No. 63/721,801, filed Nov. 18, 2024, entitled “Using Generative AI To Create Media Synopsis For Clients With Network Limitations,” which is incorporated by reference herein in its entirety.

### TECHNOLOGICAL FIELD

Exemplary embodiments of this disclosure relate generally to methods, apparatuses, or computer programs for generating a text-based description of media contained in messages to be sent to receiving devices operating in low quality telecommunications network conditions.

### BACKGROUND

Contemporary techniques to allow for telecommunications messengers to download media contained in messages may limit the quality of the downloaded media. Large media files, including photos and video, may be difficult to download because of long download times. The media may also be downloaded in ways that damages the quality of the media.

### BRIEF SUMMARY

A tool for generating a text-based description of media in messages may incorporate a machine learning model that may analyze media contained in message that may be sent over a telecommunications network. The machine learning model may then generate a text-based description of the media that may be sent to a receiving device operating in low quality telecommunications network conditions. In some exemplary aspects, low quality telecommunications network conditions may, but need not, be determined based in part on analyzing a user's behavior on a communication device of the user and identifying low network behavior. For purposes of illustration and not of limitation, for example, the user may not be utilizing videos at all in instances of determined low quality conditions or may be downloading media in determined low quality. The machine learning model may utilize this determined low network behavior associated with the communication device of the user to trigger generation of a text-based description of the media that may be sent to the communication device (e.g., a receiving device) of the user operating in the low quality condition(s). The receiving device may recreate the media based on the text-based description of the original media. The receiving unit may also request the original media to be sent to the receiving unit when the receiving unit is operating in a threshold telecommunications network quality level. In some examples, a threshold(s) telecommunications network quality level may be determined by measuring the time of the round trip of the request for an item of media content from a sending device until a time that a receiving device receives a response from the sending device. This may indicate that a network connection by a device (e.g., the receiving device) is unreliable or below an acceptable quality level in an instance in which the round trip time exceeds a predetermined threshold (e.g., a threshold time).

Methods, systems, and/or apparatuses with regard to generating a text-based description of media contained in messages are disclosed herein. A method, system, and/or apparatus may be provided to send a message that contains media over a telecommunications network; generating a text-based description of the media; and sending the text-based description of the media to receiving devices operating in one or more threshold telecommunications network conditions.

The methods, systems, and/or apparatuses to facilitate sending messages containing media over a telecommunication network that allow for training of a machine learning model on a dataset of media and its associated text-based descriptions are provided by the exemplary aspects of the present disclosure. The approach may enable the use of the machine learning model to generate a text-based description of media contained in a message to be sent to a receiving device operating in poor telecommunications network conditions. When the telecommunications network quality improves to a satisfactory level, the media itself may be provided/sent to the receiving device.

In one example of the present disclosure, a method is provided. The method may include receiving a request from a first communication device for a content item. The method may further include determining a network condition associated with the first communication device. The method may further include analyzing, by a second communication device, the content item and generating a text description of the content item in response to determining that the network condition is below a predetermined threshold denoting that a quality of telecommunications associated with the first communication device comprises an unsatisfactory quality level. The method may further include sending, by the second communication device, the text description of the content item to the first communication device to enable a display device of the first communication device to present the text description of the content item.

In another example of the present disclosure, an apparatus is provided. The apparatus may include one or more processors and a memory including computer program code instructions. The memory and computer program code instructions are configured to, with at least one of the processors, cause the apparatus to at least perform operations including receiving a request from a first communication device for a content item. The memory and computer program code are also configured to, with the processor(s), cause the apparatus to determine a network condition associated with the first communication device. The memory and computer program code are also configured to, with the processor(s), cause the apparatus to analyze the content item and generate a text description of the content item in response to determining that the network condition is below a predetermined threshold denoting that a quality of telecommunications associated with the first communication device comprises an unsatisfactory quality level. The memory and computer program code are also configured to, with the processor(s), cause the apparatus to send the text description of the content item to the first communication device to enable a display device of the first communication device to present the text description of the content item.

In yet another example of the present disclosure, a computer program product is provided. The computer program product may include at least one non-transitory computer-readable medium including computer-executable program code instructions stored therein. The computer-executable program code instructions may include program code instructions configured to receive a request from a first communication device for a content item. The computer program product may further include program code instructions configured to determine a network condition associated with the first communication device. The computer program product may further include program code instructions configured to analyze, by a second communication device, the content item and generate a text description of the content item in response to determining that the network condition is below a predetermined threshold denoting that a quality of telecommunications associated with the first communication device comprises an unsatisfactory quality level. The computer program product may further include program code instructions configured to send, by the second communication device, the text description of the content item to the first communication device to enable a display device of the first communication device to present the text description of the content item.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1A is a diagram of an exemplary network environment in accordance with an example of the present disclosure.

FIG. 1B is a diagram of an exemplary communication device in accordance with an example of the present disclosure.

FIG. 1C is a diagram of an exemplary computing system in accordance with an example of the present disclosure.

FIG. 1D illustrates an example media synopsis model in accordance with various examples of the present disclosure.

FIG. 2 illustrates an example model architecture for the disclosed method to generate a text-based description of media contained in a message in accordance with various examples of the present disclosure.

FIG. 3 illustrates an example method to generate a text-based description of media as disclosed herein in accordance with various examples of the present disclosure.

FIG. 4 illustrates a machine learning and training model in accordance with various examples of the present disclosure.

FIG. 5 illustrates an example block diagram of a device in accordance with various examples of the present disclosure.

FIG. 6 illustrates an example flowchart illustrating operations to determine text-based descriptions of media content to be delivered to devices in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

### Exemplary System Operations

Low bandwidth messenger users may find it difficult to download photos and videos because of network conditions. Text-based media may also be difficult to download in certain network conditions. Low bandwidth and limited network availability may increase message downloading times. The media from the messages may not be downloaded at all due to limited network conditions. Some existing methods for downloading media in limited network conditions may damage the media quality. These existing methods may include downloading the media in lower quality or higher compression.

The present disclosure relates to systems and/or methods to create a text-based description of media to be delivered to devices operating in limited network conditions using generative artificial intelligence (AI). The disclosed method may receive a message from a device that includes media (e.g., photos, video, or text-based media, etc.), and may generate a text-based description of the media, and may send the text-based description to a receiving device operating in limited network conditions. Some examples of the limited network conditions may be a network affected based on the type of connectivity such as, for example, a low signal (e.g., cellular signal, etc.) associated with devices connected via Fifth Generation (5G) cellular network, Long Term Evolution (LTE), High Speed Downlink Packet Access (HSDPA), or other mobile communications protocol. Another example/factor that may cause a limited network condition may be low signal strength and/or a distance to a wireless antenna (e.g., a base station antenna(s), a Wi-Fi antenna, an antenna of a router, an antenna of a modem), and/or current network traffic (e.g., bandwidth) expected or measured network congestion (e.g., bandwidth congestion). Another example/factor that may cause a limited network condition may be a communication device's (e.g., a client device(s)) current data balance/load, which may impact downloading of media items. When the receiving device begins operating in telecommunications network conditions that allow for reception of the media (e.g., threshold bandwidth satisfied/met, threshold signal strength satisfied/met, computing resource availability satisfied/met, and/or the like), the receiving device may request for the media to be sent and subsequently downloaded by the receiving device.

In some examples, the threshold(s) (e.g., a predetermined threshold(s)) may be a signal strength (e.g., lower than −40 decibel-milliwatts (dBm), lower than-70 dBm, etc.) such as an Received Signal Strength Indicator (RSSI), Signal-to-Noise Ratio (SNR), or other signal strength. In some exemplary aspects, the threshold(s) may, but need not, be determined based on a current type of connectivity, and/or based on moving from one communication protocol to another communication protocol (e.g., moving from 5G to LTE, etc.). In some other examples, the threshold(s) may be determined based on a wireless Wi-Fi network connection rate (e.g., a connection rate of 25 megabits per second (Mbps) or less). In yet some other examples, the threshold(s) may be determined based on when a certain time occurs (e.g., night time (e.g., 9 PM to 4 AM)) in which network bandwidth may be more available than other times (e.g., 7 AM to 12 PM), and thus the network's data rate may be available/uncongested and in which data rates to communicate across the network may be cheaper (e.g., lower costs) than at other times. In this regard, an example of the threshold(s) may be 90% percent available network bandwidth, or other available percentage (e.g., 80%) network bandwidth. In some other examples, the threshold may be based on communication device (e.g., a client device) resource availability (e.g., processor resources/computation capability below a level (e.g., a low central processing unit (CPU) usage value (e.g., below 50%, below 40%, etc.)), or when the communication device has a load exceeding a level, such as for example 90% of the communication device's bandwidth is unavailable due to current downloading or receipt of data/media items/content by the communication device. In this regard, in this example 10% bandwidth may be available for download/receipt of other data/media items/content, which may be suboptimal or insufficient for good data transfer results.

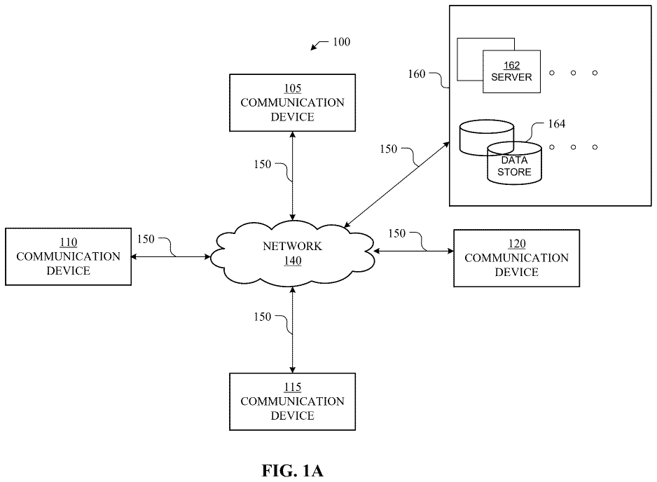

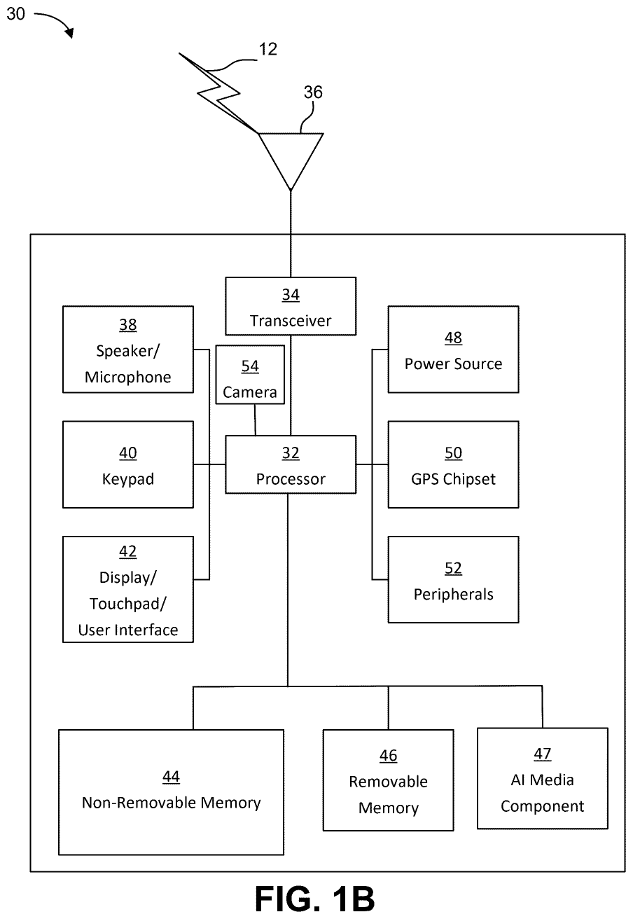

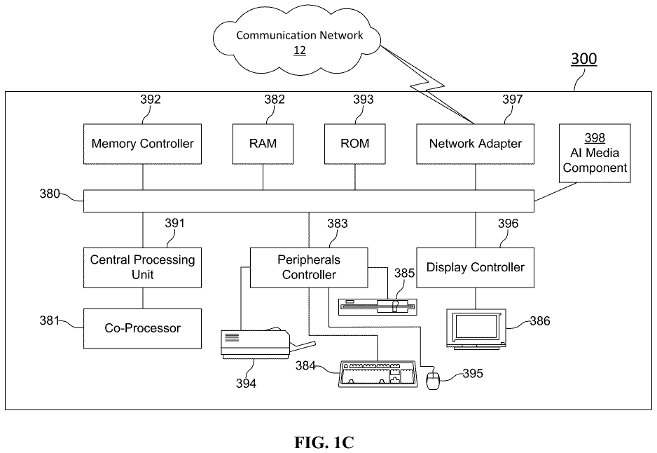

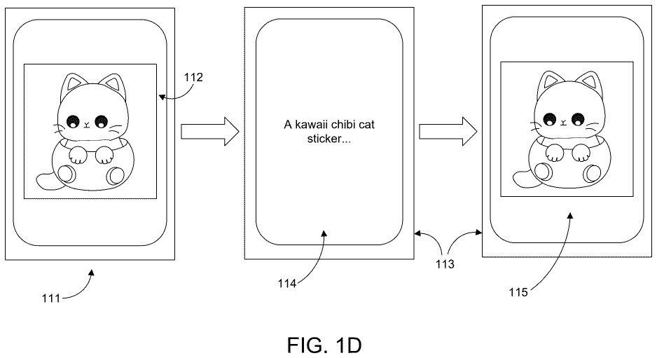

The disclosed subject matter may enable several innovations. The disclosed techniques may enable the use of AI to generate a text-based description of media sent over a telecommunication network (e.g., network 140 of FIG. 1A). The text-based description may be sent to one or more receiving devices. The disclosed technique may further enable the use of AI to generate media on the receiving device(s) based on the text-based description received.

### Exemplary System Architecture

Reference is now made to FIG. 1A, which is a block diagram of a system according to exemplary embodiments. As shown in FIG. 1A, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1A shows one network device 160 and four communication devices 105, 110, 115 and 120, any suitable number of network devices 160 and communication devices 105, 110, 115 and 120 may be part of the system of FIG. 1A without departing from the spirit and scope of the present disclosure.

### Exemplary Communication Device

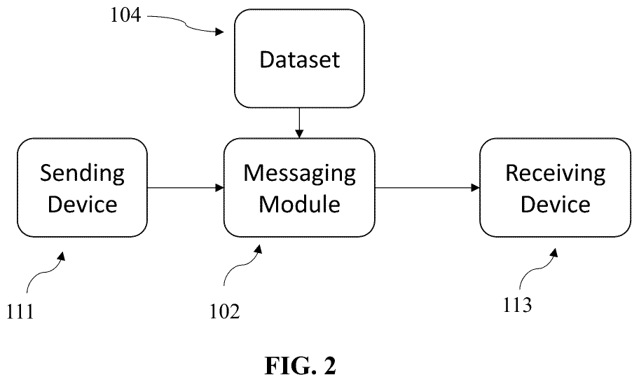

FIG. 1B illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

The UE 30 may further include an AI media component 47 that may initially receive a short description (e.g., text message) of a requested media content item(s) (e.g., an image(s), a video(s)) in response to determining that one or more network conditions are unsatisfactory (e.g., below a predetermined threshold(s)). In an instance in which the AI media component 47 determines that the one or more network conditions are satisfactory (e.g., a predetermined threshold(s) is satisfied/met), the AI media component 47 may send a request to another device (e.g., a network device (e.g., network device 160)) to receive the media content item(s) itself. In some other examples, the AI media component 47 may generate a trigger presenting an option to a display (e.g., display, touchpad, user interface 42) for a user to make a selection to request download of the media content item(s) which may cause sending of a request to the other device (e.g., network device 160) to send the media content item(s) itself to the UE 30.

### Exemplary Computing System

FIG. 1C is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

The computing system 300 may also include an AI media component 398 that may receive a request from a device (e.g., UE 30) for a media content item(s) (e.g., an image(s), a video(s)) and may determine that network conditions are currently below a desired level and may be unsatisfactory (e.g., below a predetermined threshold(s). In response to determining that the network conditions are below the desired level/unsatisfactory, the AI media component 398 may analyze the requested media content item(s) and may generate a short description (e.g., text message) of a requested media content item(s). The AI media component 398 may send the requesting device the short description of the media content item(s). In response to the AI media component 398 determining, or receiving a message from AI media component 47, that the network conditions are above a desired level and are satisfactory (e.g., above a predetermined threshold(s)), the AI media component 398 may send the actual media content item(s) (e.g., the image(s), the video(s)) to the receiving device (e.g., UE 30).

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 1B, to enable the computing system 300 to communicate with other nodes (e.g., UE 30) of the network.

FIG. 1D illustrates an example media synopsis model. A message with input media 112 may be sent from a sending device 111. A description 114 (also referred to herein as description message 114) of the input media 112 may be generated based on the determined context of the input media 112 and sent to a receiving device 113. In some example aspects, an AI media component (e.g., AI media component 398 or AI media component 47) may analyze the context of the input media 112 and may determine the description 114 message. An output media 115 may be generated on the receiving device 113 based on the description 114 of the input media 112. In some examples, the AI media component may generate or provide the media 115 to the receiving device 113 in an instance in which the AI media component determines that network conditions are a sufficient quality level (e.g., exceeds a predetermined threshold(s)). An example message may contain a picture (e.g., input media 112) of a kitten in a pumpkin. An example text-based description message (e.g., description message 114) of the input media 112 may be generated, by the AI media component, as “A kawaii chibi cat sticker features a round brown tabby kitten sitting inside and hugging an orange pumpkin. The cat has large sparkly blue eyes, pink blush marks on its cheeks, and simple line art details. The art style is simple and cartoon-like, with a white border around the edges that creates a sticker-like appearance. The overall mood is cozy and adorable, rendered in soft colors...” The example text-based description message (e.g., description message 114) of the input media 112 may be generated and shown (in a summary or shortened manner) as “A kawaii chibi cat sticker. . .” in FIG. 2. In some examples, selecting the text “A kawaii chibi cat sticker. . .” may trigger presentation/showing of the entire text-based description message (e.g., description message 114) described above. One or more devices (e.g., receiving device 113) may receive the message 114 containing the text-based description. The receiving device may opt to receive the original message containing the input media 112. For example, in an instance in which the AI media component determines that network conditions are at a satisfactory level (e.g., a predetermined threshold(s) is satisfied/met), the AI media component (e.g., AI media component 47) of a receiving device may send a request to a network device (e.g., network device 160 of FIG. 1A) to receive the input media 112. In this regard, the network device may send the input media 112 to the receiving device (e.g., receiving device 113).

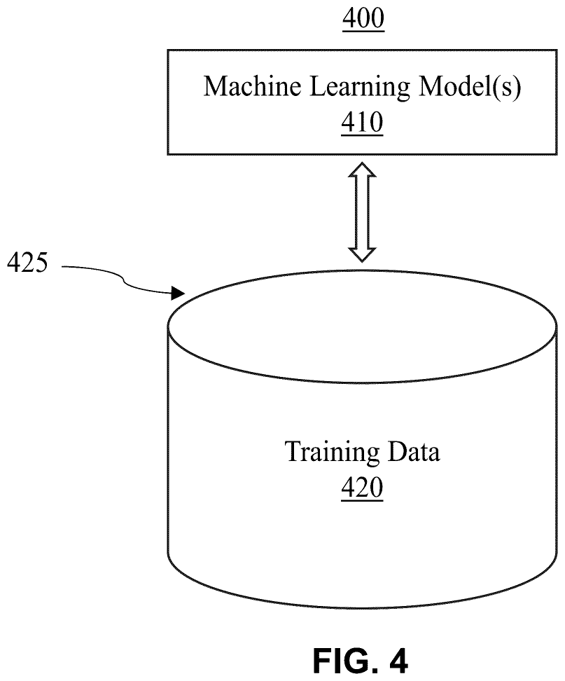

FIG. 2 illustrates an example media synopsis generation model architecture. A messaging module 102 may include a machine learning (ML) model (e.g., machine learning model(s) 410 of FIG. 4) and may generate a description 114 of input media 112 contained in a message that may be sent from sending device 111 to receiving device 113. In some other exemplary aspects, the messaging module 102 may function as an AI media component (e.g., AI media component 47 or AI media component 398). In some example aspects, the sending devices 111 may be examples of network devices 160. In some other example aspects, the sending devices 111 and the receiving devices 113 may be examples of communication devices 105, 110, 115, 120. Multiple devices may receive the message. The machine learning model may be trained on a dataset 104 (e.g., training data 420 of FIG. 4) to enable the machine learning model to generate a text-based description of input media 112 contained in a message. Dataset 104 may include examples of multiple items of media and their associated text-based descriptions.

The ML model contained in the messaging module 102 may be trained to generate output media 115 from description 114 of input media 112 contained in a message sent from sending device 111 to receiving device 113. Output media 115 generated from description 114 may be displayed on receiving device 113. For instance, the receiving device 113 may include a display device (e.g., the display, touchpad, user interface 42) configured to display/present the output media 115. Input media 112 may be received by receiving device 113 based on a user profile setting or other indication (e.g., received selection). In some examples, a user of a receiving device 113 may indicate in a setting of their user profile to receive a textual description of requested media when network conditions are suboptimal and/or the user may indicate in a setting of their user profile a preference to receive an animated version of requested media when network conditions are suboptimal. In this manner, when network conditions are suboptimal, a network device may send the receiving device a textual description of requested media and/or the animated version of the requested media. In some examples, the animated version of the media content may be generated in a predetermined drawing style.

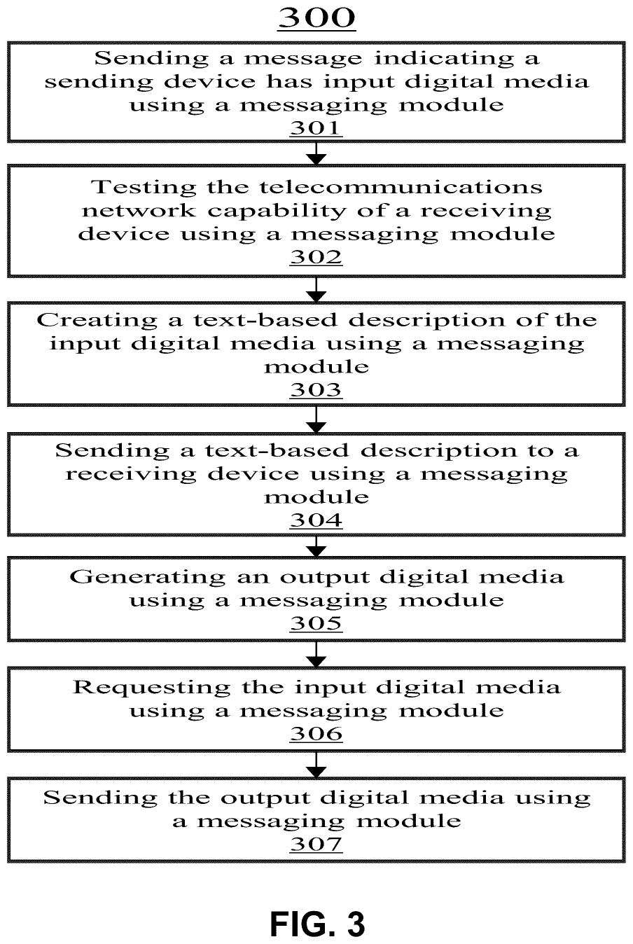

FIG. 3 illustrates an example method 300 to generate a description 114 of an input media 112 contained in a message sent from sending device 111 to receiving device 113. At step 301, a message indicating that the sending device has input media 112 may be sent from sending device 111 to receiving device 113 using messaging module 102. In this exemplary aspect, the messaging module 102 may operate as an AI media component (e.g., AI media component 398 and/or AI media component 47). As described above, the message indicating that the sending device has input media 112 may be sent to the receiving device 113. In this regard, the sending device 111 may generate the input media 112 or retrieve the input media 112 to send to the receiving device. For instance, the sending device may retrieve or access the input media 112 from dataset 104. Sending device 111 may send a message to multiple receiving devices 113. The sending device may send a message to multiple receiving devices in response to exchanging data with the receiving devices to understand the receiving devices network conditions (e.g., to determine if current network conditions and/or if the receiving device conditions are suboptimal). At step 302, messaging module 102 may be used to test the telecommunications network capability of receiving device 113. In some example aspects, the telecommunications network may be network 140 and/or may be system 100. Messaging module 102 may test the telecommunications network regarding bandwidth, resource availability (e.g., computing resource availability), signal strength, or any other criteria that may affect the receiving device's 113 ability to download media, or receive media, contained in a message. In some examples, the telecommunications network may be tested to determine signal strengths, distance from an antenna(s), and/or network type(s) (e.g., a Fourth Generation (4G) network, a 5G network, LTE, HSDPA, etc.). In other examples, the telecommunications network may be tested based on device base limits such as, for example, a device's network being limited by other service(s) utilizing the network), and/or based on client preference base constraints such as, for example, data package limits (e.g., device data package being utilized at 90% or more, which may indicate a suboptimal network condition(s)), preferences/designations to view synopses of media (e.g., requested media). In some examples, an AI media component (e.g., AI media component 47, AI media component 398) may make these measurements/determinations regarding the testing of the telecommunications network and/or network conditions. At step 303, description 114 of input media 112 may be created by messaging module 102. Description 114 may be generated automatically upon the receiving device 113 sending the message to request input media 112, based on receiving device's 113 network capability being below a threshold level, or some other metric(s). In some exemplary aspects, the sending device (e.g., sending device 111) may send a message with a token (e.g., a cookie (e.g., an HTTP cookie)) to a receiving device (e.g., receiving device 113) which may trigger the receiving device to send a request to the sending device to download requested media content. In this regard, the system(s) of the exemplary aspects may make communication efficient and fast and may minimize network roundtrip times. For example, the messaging module 102 (e.g., AI media component 398) of the sending device 111 may automatically generate the description 114 of the input media 112 in response to receipt of a message by the receiving device 113 requesting the input media 112 and in response to determining that the receiving device's 113 network capability is below a predetermined threshold level(s). In some examples, the sending device 111 may determine that the receiving device's 113 network capability is below the predetermined threshold by sending a message to the receiving device 113 asking the receiving device 113 to provide/send its current network capabilities. In some other examples, the receiving device 113 may ensure to register its current capabilities with the sending device 111 or with another entity or device (e.g., computer system 500) to which the sending device 111 may query and retrieve the current state of the receiving device's 113 network capabilities from the other entity or device. At step 304, description 114 may be sent to receiving device 113 by messaging module 102. For instance, the messaging module 102 (e.g., AI media component 398) of sending device 111 may send the description 114 to the receiving device 113. Description 114 may be sent to one or more receiving devices. In this example, the messaging module 102 (e.g., AI media component 398) of the sending device 111 may send the description 114 to the receiving device 113 in response to determining that one or more network conditions associated with the receiving device 113 are below a predetermined threshold(s) (e.g., below a bandwidth threshold, below a computer resource availability threshold, below a signal strength threshold, etc.). Detection of network conditions being below the predetermined threshold(s) may signify or denote that the network conditions associated with the receiving device 113 are below a threshold quality level (e.g., the network conditions are low quality).

At step 305, output media 115 may be generated for the receiving device 113 by a messaging module 102. For example, the output media 115 may be generated by the messaging module 102 (e.g., AI media component 398) of the sending device 111 for the receiving device 113. Output media 115 may be generated based on the description 114 of input media 112. At step 306, receiving device 113 may request input media 112 by using a messaging module 102 (e.g., AI media component 47) of the receiving device 113. At step 307, the message containing output media 115, which is associated with, or the same as input media 112, may be sent to receiving device 113 by messaging module 102 (e.g., AI media component 398) of the sending device 111. In this example, when/in an instance in which the messaging module determines that the one or more network conditions equal or exceed the predetermined threshold(s), the messaging module 102 (e.g., AI media component 398) of the sending device 111 may send the output media 115 to the receiving device 113. The determinations of the predetermined threshold(s) being equaled or exceeded may be determinations by the messaging module 102 (e.g., AI media component 47 or AI media component 398) that a bandwidth threshold is equaled/exceeded, that a computer resource(s) availability threshold is equaled/exceeded, that a signal strength threshold is equaled/exceeded, or other quality metric(s) threshold is equaled/exceeded. In some examples, the receiving device 113 may make the determination that the current network conditions exceed the predetermined threshold and the receiving device 111 may send such indication to the sending device 113. In this regard, a display device (e.g., the display, touchpad, user interface 42) of the receiving device 113 may present/show the output media 115. A user of the receiving device 113 may be able to interact with the output media 115 by the display device. For purposes of illustration and not of limitation, in some example aspects, a user of the receiving device 113 may click, via the display device, the text of the description 114 and in response to receipt of the indication of the selection, the receiving device may request, or download, the input media 112 which may be provided by the sending device 111 to the receiving device 113 as media output 115.

As described above, the sending device may create the synopses (e.g., generated summaries) of requested media (e.g., input media 112) from a requesting device when network conditions are suboptimal. In this regard, the sending device (e.g., sending device 111) may create the synopses and may facilitate encryption base messaging with the receiving device (e.g., receiving device 113) when the sending device determines that bandwidth (e.g., network bandwidth) and/or other network conditions are limited. In some other examples, in situations in which computation resources (e.g., processing resources) may be bounded/limited on a requesting device, the sending device may send requested media to another device (e.g., a server or network device (e.g., computer system 500)) which may enable the other device to send the receiving device the requested media content when the other device (e.g., computer system 500) determines that network conditions are optimal (e.g., at or above a threshold level).

In an example, the messaging module 102 may be contained on the sending devices 111 and/or receiving devices 113. This example may allow for end-to-end encryption of the message(s) sent from the sending device(s) 111 to the receiving device(s) 113.

In another example, messaging module 102 may be contained in a server located outside of the sending device 111 or receiving device 113. In this example, the messaging module 102 (e.g., AI media component 47 or AI media component 398) may test the receiving device's 113 telecommunications network quality (e.g., Received Signal Strength Indicator) prior to generating the description 114 of the media 112. In this example, the description 114 may be generated automatically at the time the sending device 111 attempts to send the message containing the description 114 of the media 112.

Methods, systems, and/or apparatuses with regard to generating a text-based description of media using generative AI are disclosed herein. A method, system, and/or apparatus may be provided for sending a message that contains media over a telecommunications network using a messaging module; generating a text-based description of the media; and sending the text-based description of the media to receiving devices operating in low telecommunications network conditions.

A method to generate a text-based description of media, comprising: sending a message containing input media; testing a telecommunications network quality for a receiving device; generating a text-based description of the media; sending a text-based description of the media to a receiving device; generating an output media in a receiving device; and requesting the input media to be sent to a receiving device. The messaging module may comprise a machine learning model that may be trained on a dataset comprising example media and their descriptions. The receiving device may comprise one or more devices. The method may include all combinations (including the removal and/or addition of steps) in this paragraph and previous paragraphs are contemplated in a manner that is consistent with the other portions of the detailed description.

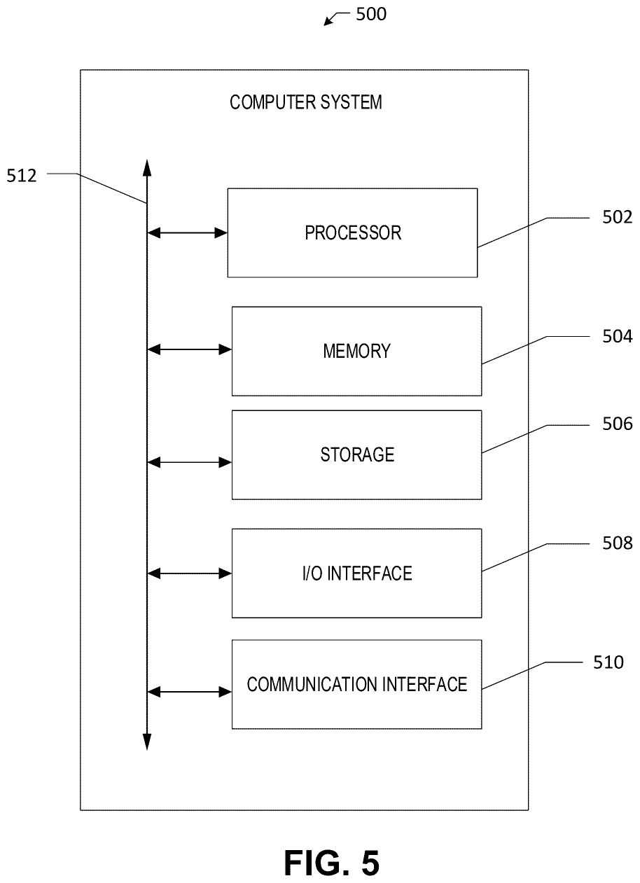

FIG. 4 illustrates a framework 400 employed by a software application (e.g., computer code, a computer program) to generate a text-based media description, in accordance with aspects discussed herein. The framework 400 may be hosted remotely. Alternatively, framework 400 may reside within a media synopsis model and may be processed by the computing system 500 shown in FIG. 5. Additionally or alternatively, the framework 400 may reside within and may be executed/implemented by the network device 160 of FIG. 1A, the UE 30 of FIG. 1B, and/or the computer system 300 of FIG. 1C. Machine learning model(s) 410 may be operably coupled with the stored training data 420 in a database 425. Machine Learning (ML), Neural Network (NN), Artificial Intelligence (AI), and large language model (LLM) are generally used interchangeably herein. Additionally, the machine learning model(s) 410 may be processed by one or more processors (e.g., processor 32 of FIG. 1B, coprocessor 81 of FIG. 1C, processor 502 of FIG. 5). In some examples, the machine learning model(s) 410 may be associated with operations (or performing operations) of FIG. 3. In some other examples, the machine learning model(s) 410 may be associated with other operations. In some examples, the machine learning model(s) 410 may be an example of the AI media component 47, and/or the AI media component 398.

In an example, the training data 420 may include attributes of thousands of objects. For example, the object(s) may be identified or associated with user profiles, posts, photographs/images, videos, augmented reality data, sensor data (e.g., capacitive based sensors, magnetic based sensors, resistive based sensors, pressure-based sensors, or audio-based sensors), or the like. The training data 420 employed by machine learning model(s) 410 may be fixed or updated periodically. Alternatively, training data 420 may be updated in real time or near real time based upon the evaluations performed by machine learning model(s) 410 in non-training mode. In some examples, the training data 420 may, but need not, be predefined as inputs to the machine learning model(s) 410. For example, the training data 420 may include predetermined or pre-captured images, videos, clips, animations, or the like and associated audio content and/or associated/corresponding text descriptions to enable the machine learning model(s) 410 to be able to analyze new images and new videos and determine/generate an associated text based description for these new images and new videos. In some examples, some of the content items of the training data 420 may signify measurements of good network conditions (as for a high quality network) associated with a network (e.g., network 140) or system (e.g., system 100) that may enable the machine learning model(s) 410 to automatically know/determine when to obtain or generate an original requested image or original requested video being requested by a receiving/requesting device to provide such original image or original video in response to determining that the network conditions exceed one or more predetermined network condition(s) thresholds. In some other examples, some of the content items of the training data 420 may signify measurements of low quality network conditions. Additionally, in some examples, predetermined network condition(s) thresholds may be included in the training data 420. In some examples, the training data 420 may, but need not, include information on network quality. Additionally, in some examples, the training data 420 may, but need not, include distinctions on when to utilize/provide synopses of media items and/or when to transfer the media items to a requesting entity/device.

In some examples, the training data may have a score(s) of relevance of the synopses associated with media items in which the score(s) may denote accuracy of a synopsis (e.g., a generated summary of a media item) to a corresponding media item. This may be useful in order to balance between creating synopses and sending the associated media item(s) to a device (e.g., a requesting device). The exemplary aspects may also generate and apply a set of synopses for each corresponding media item(s), for example, each with a different generation factor. For example, in an instances in which there may be 3 varying images of a dog and/or a dog and its owner, the exemplary aspects may generate a set of synopsis (e.g., generated summary of the media item(s)) such as a dog, a dog wagging it's tail, an old dog wagging it's tail when the dog recognizes its owner.

A technical problem(s) being solved by the exemplary aspects of the present disclosure is how to transfer data efficiently and quickly between two endpoints (e.g., two communication devices) when the network is a constraining factor. The exemplary aspects of the present disclosure may utilize AI to summarize media into a synopsis and later may expand the synopsis back to the media and/or may obtain a similar/near identical/better representation of the media to provide to a requesting device, when network conditions are more favorable/sufficient level of network quality. In this manner, the exemplary aspects may enable a network (e.g., network 140, system 100) to conserve bandwidth when needed and to improve messaging latency allowing for more communication to occur between the two endpoints (e.g., two communication devices).

In operation, the machine learning model(s) 410 may evaluate attributes of images, audio, videos, capacitance, resistance, or other information obtained by hardware (e.g., sensors, peripherals, etc.). For example, aspects of a user profile, posts, images, resistance, capacitance, audio, pressures, size, shape, orientation, position of an object(s) and the like may be ingested and analyzed. The attributes of any of the above may then be compared with respective attributes of stored training data 420 (e.g., prestored objects). The likelihood of similarity between each of the obtained attributes and the stored training data 420 (e.g., prestored objects) may be given a determined confidence score. In one example, if the confidence score exceeds a predetermined threshold, the attribute is included in an instruction that is ultimately communicated, which may be to a user via a user interface of a computing device (e.g., computing system 700, UE 30 of FIG. 1B). The sensitivity of sharing more or less attributes may be customized based upon the needs of the particular device.

FIG. 5 illustrates an example computer system 500. One or more computer systems 500 perform one or more steps of one or more methods described or illustrated herein. In particular embodiments, one or more computer systems 500 provide functionality described or illustrated herein. In examples, software running on one or more computer systems 500 performs one or more steps of one or more methods described or illustrated herein or provides functionality described or illustrated herein. Examples include one or more portions of one or more computer systems 500. Herein, reference to a computer system may encompass a computing device, and vice versa, where appropriate. Moreover, reference to a computer system may encompass one or more computer systems, where appropriate.

The computer system 500 includes a processor 502 and memory 504. The memory 504 stores instructions that, when executed by the processor 502, cause the computer system 500 to implement the media content functionality described herein. The computer system 500 may be communicatively connected with sending device 111, receiving device 113, a display for presenting an input message and/or a received message.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In examples, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In examples, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In examples, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In examples, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In examples, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In examples, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In examples, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In examples, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example, and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

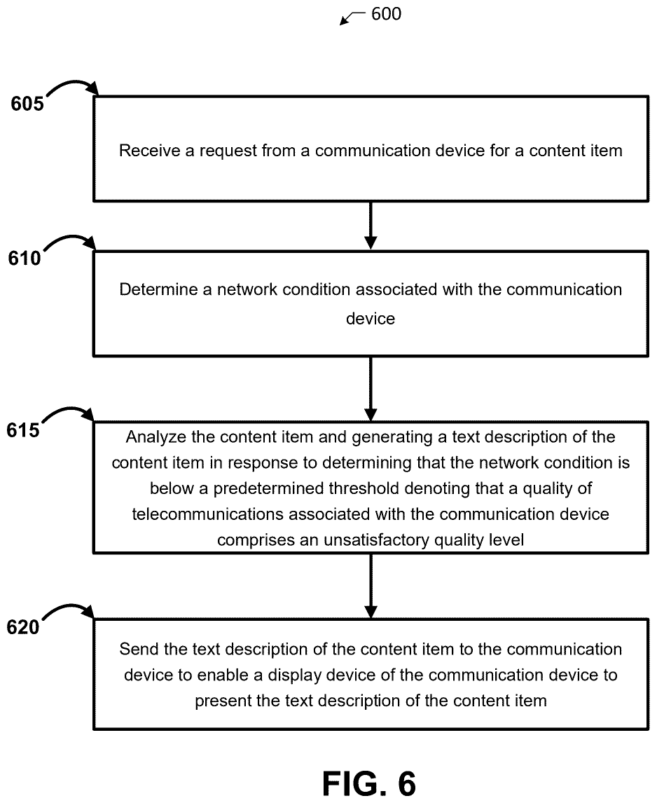

Referring now to FIG. 6, an exemplary process 600 to determine text-based descriptions of media content to be delivered to devices is provided in accordance with exemplary aspects of the present disclosure. At operation 605, a computing device (e.g., an AI media component 398 of a sending device 111) may receive a request from a communication device (e.g., receiving device 113) for a content item (e.g., input media 112). At operation 610, a computing device (e.g., an AI media component 398 of the sending device 111) may determine a network condition associated with the communication device.

At operation 615, a computing device (e.g., an AI media component 398 of the sending device 111) may analyze the content item and may generate a text description (e.g., text description 114) of the content item (e.g., input media 112) in response to determining that the network condition is below a predetermined threshold. In an instance in which the network condition is determined as being below the predetermined threshold, such denotes that a quality of telecommunications associated with the communication device comprises an unsatisfactory quality level (e.g., a low quality level or a low quality telecommunications network).

At operation 620, a computing device (e.g., an AI media component 398 of the sending device 111) may send the text description (e.g., text description 114) of the content item to the communication device to enable a display device (e.g., display, touchpad, user interface 42) of the communication device to present the text description of the content item. In some exemplary aspects, the computing device may send the content item to the communication device in response to determining that the network condition equals or exceeds the predetermined threshold. In an instance in which the network condition equals or exceeds the predetermined threshold such may denote that the telecommunications associated with the communication device comprises a satisfactory quality level (e.g., a high quality level or a high quality telecommunications network).

The sending of the content item, by the computing device, to the communication device enables the display device (e.g., display, touchpad, user interface 42) of the communication device to present the content item. A user of the communication device may interact with/engage with the content item via the display device. The predetermined threshold may comprise a network bandwidth threshold, a resource availability threshold (e.g., a computer resource availability threshold), or a signal strength threshold of the communication device.

The sending of the content item, by the computing device, to the communication device may further be in response to receipt of a second request for the content item in response to the communication device detecting a selection, via the display device, of the text description (e.g., text description 114) of the content item (e.g., input media 112). In some exemplary aspects, the sending of the content item, by the computing device, to the communication device is automatic in response to determining that the network condition equals or exceeds the predetermined threshold.

The computing device (e.g., sending device 111) may implement a machine learning model (e.g., machine learning model(s) 410, an AI media component 398) to determine the text description of the content item. The computing device, when implementing the machine learning model, may cause the machine learning model to analyze a plurality of predetermined thresholds associated with network conditions in training data (e.g., training data 420, dataset 104) of the machine learning model to determine whether the predetermined threshold is equaled or exceeded. The text description (e.g., text description 114) may include a generated summary of the content item (e.g., input media 112) and the content item may include an image, a video, or any other suitable media content item (e.g., an animation(s), an audio message(s), etc.). For purposes of illustration and not of limitation, for example, in an instance in which the media content item may be an audio message, or audio content, or the like associated with a 120 second audio recording of users drinking and purchasing coffee at a location, the computing device (e.g., sending device 111) may create a synopsis (e.g., generated summary) of the audio recording such as, for example, a summary of an audio output indicating “I wish you to buy me coffee.”

### Alternative Aspects

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of the disclosed components, among other things as disclosed herein. For example, one skilled in the art will recognize that the disclosed media messaging method, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure - the disclosed media messaging method-as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method comprising:
receiving a request from a first communication device for a content item;
determining a network condition associated with the first communication device;
analyzing, by a second communication device, the content item and generating a text description of the content item in response to determining that the network condition is below a predetermined threshold denoting that a quality of telecommunications associated with the first communication device comprises an unsatisfactory quality level; and
sending, by the second communication device, the text description of the content item to the first communication device to enable a display device of the first communication device to present the text description of the content item.

2. The method of claim 1, further comprising:
sending, by the second communication device, the content item to the first communication device in response to determining that the network condition equals or exceeds the predetermined threshold, which denotes that the telecommunications associated with the first communication device comprises a satisfactory quality level.

3. The method of claim 2, wherein the sending the content item to the first communication device enables the display device of the first communication device to present the content item.

4. The method of claim 1, wherein the predetermined threshold comprises a network bandwidth threshold, a resource availability threshold, or a signal strength threshold of the first communication device.

5. The method of claim 2, wherein the sending the content item to the first communication device is further in response to receipt, by the second communication device, of a second request for the content item in response to the first communication device detecting a selection, via the display device, of the text description of the content item.

6. The method of claim 2, wherein the sending the content item to the first communication device is automatic, by the second communication device, in response to the determining that the network condition equals or exceeds the predetermined threshold.

7. The method of claim 1, wherein the second communication device implements a machine learning model to determine the text description of the content item.

8. The method of claim 7, wherein the second communication device, when implementing the machine learning model, causes the machine learning model to analyze a plurality of predetermined thresholds associated with network conditions in training data of the machine learning model to determine whether the predetermined threshold is equaled or exceeded.

9. The method of claim 1, wherein the second communication device comprises a network device.

10. The method of claim 1, wherein the text description comprises a generated summary of the content item and the content item comprises an image, a video, an animation, or audio content.

11. An apparatus comprising:
one or more processors; and
at least one memory storing instructions, that when executed by the one or more processors, cause the apparatus to:
receive a request from a first communication device for a content item;
determine a network condition associated with the first communication device;
analyze the content item and generate a text description of the content item in response to determining that the network condition is below a predetermined threshold denoting that a quality of telecommunications associated with the first communication device comprises an unsatisfactory quality level; and
send the text description of the content item to the first communication device to enable a display device of the first communication device to present the text description of the content item.

12. The apparatus of claim 11, wherein when the one or more processors further execute the instructions, the apparatus is configured to:
send the content item to the first communication device in response to determining that the network condition equals or exceeds the predetermined threshold, which denotes that the telecommunications associated with the first communication device comprises a satisfactory quality level.

13. The apparatus of claim 12, wherein the send of the content item to the first communication device enables the display device of the first communication device to present the content item.

14. The apparatus of claim 11, wherein the predetermined threshold comprises a network bandwidth threshold, a resource availability threshold, or a signal strength threshold of the first communication device.

15. The apparatus of claim 12, wherein when the one or more processors further execute the instructions, the apparatus is configured to:
perform the send of the content item to the first communication device in response to receipt of a second request for the content item in response to the first communication device detecting a selection, via the display device, of the text description of the content item.

16. The apparatus of claim 12, wherein when the one or more processors further execute the instructions, the apparatus is configured to:
perform the send of the content item to the first communication device automatically in response to the determining that the network condition equals or exceeds the predetermined threshold.

17. The apparatus of claim 11, wherein the apparatus is configured to implement a machine learning model to determine the text description of the content item.

18. The apparatus of claim 17, wherein when the one or more processors further execute the instructions, the apparatus is configured to:
perform the implement the machine learning model, causing the machine learning model to analyze a plurality of predetermined thresholds associated with network conditions in training data of the machine learning model to determine whether the predetermined threshold is equaled or exceeded.

19. A non-transitory computer-readable medium storing instructions that, when executed, cause:
receiving a request from a first communication device for a content item;
determining a network condition associated with the first communication device;
analyzing, by a second communication device, the content item and generating a text description of the content item in response to determining that the network condition is below a predetermined threshold denoting that a quality of telecommunications associated with the first communication device comprises an unsatisfactory quality level; and
sending, by the second communication device, the text description of the content item to the first communication device to enable a display device of the first communication device to present the text description of the content item.

20. The computer-readable medium of claim 19, wherein the instructions, when executed, further cause:
sending, by the second communication device, the content item to the first communication device in response to determining that the network condition equals or exceeds the predetermined threshold, which denotes that the telecommunications associated with the first communication device comprises a satisfactory quality level.
